(19) United States
(12) Patent Application Publication
(10) Pub. No.: US 2014/0050995 A1
(43) Pub. Date: Feb. 20, 2014

(54) METAL-FREE OXYGEN REDUCTION ELECTROCATALYSTS

(71) Applicant: Liming Dai, Solon, OH (US)

(72) Inventor: Liming Dai, Solon, OH (US)

(21) Appl. No.: 14/002,590

(22) PCT Filed: Mar. 1, 2012
(86) PCT No.: PCT/US12/27241

§ 371 Date: Nov. 5, 2013

(30) Foreign Application Priority Data
Mar. 1, 2011 (US) 61447757

(51) Int. Cl. H01M 4/90

(52) U.S. Cl. CPC H01M 4/9008
USPC 429/405; 429/532; 429/531; 429/513; 502/1

(57) ABSTRACT

An electrocatalyst material comprising a functionalized catalytic substrate, the catalytic substrate comprising an electron-accepting material adsorbed thereto. In one embodiment, the catalytic substrate comprises carbon nanotubes or graphene sheets having a nitrogen-containing or nitrogen-free polyelectrolyte, e.g., poly(diallyldimethylammonium chloride) (PDDA), adsorbed thereto. The electrocatalyst material exhibits excellent catalytic activity, as well as broad fuel selectivity, resistance to poisoning effects, and durability. The electrocatalyst can be used as part of an electrode structure, e.g., a cathode, that can be used in a wide range of electrochemical devices.

### CROSS REFERENCE TO RELATED APPLICATIONS

This application is a National Phase Application of International Application No.: PCT/US2012/027241, entitled “Metal-Free Oxygen Reduction Electrocatalysts” filed Mar. 1, 2012, which claims the benefit of U.S. Provisional Application No. 61/447,757, entitled “Metal-Free Oxygen Reduction Electrocatalysts,” filed Mar. 1, 2011, which are each incorporated by reference herein in its entirety.

### GOVERNMENT SPONSORSHIP

This invention was made with United States government support awarded by the National Science Foundation under CMMI-1000768 and the Air Force Office of Scientific Research under FA2386-10-1-4071 and FA9550-09-1-02331.

### FIELD OF THE INVENTION

The present disclosure is generally related to metal-free functionalized carbon nanomaterials suitable for use as an electrocatalyst. The present disclosure also relates to systems, electrochemical devices, and processes employing such materials and electro catalysts.

### BACKGROUND

Electrochemical cells may be used in a variety of applications such as fuel cells, as a power source. An electrochemical fuel cell generally includes two electrodes that are in electrical contact with one or more electrolytes. An electrically insulating, ion-permeable membrane may also be situated within the electrolyte. Because the membrane is electrically insulating, electrons formed at the anode are forced to travel through an external circuit back to the cathode to maintain the cathode reaction. The flow of electrons can be used to supply power to devices connected to the external circuit or can be fed into an energy storage system such as a capacitor.

The electrochemical reaction within a fuel cell generates electricity, water, and heat from an oxidant source such as oxygen and a fuel source such as, for example, hydrogen. As one specific example, in an alkaline hydrogen fuel cell, oxygen is passed over the cathode to be reduced, and hydrogen is passed over the anode to be oxidized. This oxidation-reduction may occur by several different pathways, depending on the chosen electrolyte and membrane. For example, in an alkaline electrolyte with a hydroxyl-permeable membrane intermediate hydroxyl ions flow from the cathode, through the membrane, and to the anode to be combined with hydrogen. Such an oxidation-reduction may occur through a “four-electron pathway” according to the following reactions:

Cathode side half-reaction (alkaline electrolyte): O₂+2H₂O+4e⁻→4OH⁻

Anode side half-reaction (alkaline electrolyte): 2H₂+4OH⁻→4H₂O+4e⁻

Net reaction: 2H₂+O₂→2H₂O

A less efficient “two-electron pathway” also is possible where peroxide ions are formed instead of hydroxyl ions. This results in one part H₂O₂ as an intermediate product of the reaction between one part H₂ and one part O₂.

Other types of fuel cells may employ acidic electrolytes with cation-permeable membranes, such that intermediate ions (protons) flow from the anode, through the electrolyte, to the cathode to be combined with oxygen. An example four-electron pathway in a hydrogen fuel cell with acidic electrolyte involves the following reactions:

Cathode side half-reaction (acidic electrolyte): O₂+4e⁻→2O²⁻

Anode side half-reaction (acidic electrolyte): 2H₂→4H⁺+4e⁻

Net reaction: 2H₂+O₂→4H⁺+2O²⁻2H₂O

The reactions applicable to a hydrogen fuel cell are shown for their relative simplicity. Other fuels and oxidants can be employed in fuel cells including alcohols such as methanol, or complex molecules such as glucose or other sugars. Regardless of the fuel, in any fuel cell employing one of the above four- or two-electron pathways, the cathode side half-reaction is known as an oxygen-reduction reaction (ORR). Thermodynamics and kinetics of the ORR typically require a cathode catalyst to ensure technically useful output of the fuel cell. The activity of electrocatalysts for the oxygen reduction reaction (ORR) affects the electrochemical performance of fuel cells and metal-air batteries. Common catalysts for the oxygen reduction at the cathode have included noble metal catalysts such as platinum-group metals or their alloys.

Although platinum-based electrocatalysts have been traditionally used to catalyze the ORR with a high efficiency, they suffer from several serious problems, including the crossover effect and deactivation by catalyst poisons such as carbon monoxide (CO). Recent research efforts in reducing or replacing expensive platinum electrodes in fuel cells have focused on platinum-based alloys, transition metal oxide and organic complexes, carbon-nanotube-supported metal particles, enzymatic electrocatalytic systems, and conducting polymer coated membranes. The high cost of platinum catalysts, together with its limited reserves in nature, has severely hindered the large-scale commercialization of fuel cells employing such catalysts. Suitable, efficient, stable, and low-cost ORR electrocatalysts that would allow for mass marketing of fuel cell technology are generally not available at this time.

### SUMMARY

The present invention provides a metal-free electrocatlyst material. In one aspect, the present invention provides an electrocatalyst material comprising a functionalized catalytic substrate having an electron-accepting material adsorbed thereto. The electrocatalyst materials provide a catalytic material exhibiting a catalytic activity as good as, if not better than, conventional Pt/C catalysts, but exhibit better fuel selectivity, greater resistance to poisoning effects, and/or greater durability including greater corrosion resistance than conventional Pt/C catalysts. While not being bound to any particular theory, the catalytic activity may stem from a net positive charge created on the substrate from the electron-accepting ability of the electron-accepting material adsorbed thereto. Additionally, the present catalyst materials provide a catalyst that is significantly less expensive than conventional platinum based catalysts.

In one aspect, the present invention provides an electrocatalyst comprising a functionalized catalytic substrate. The catalytic substrate can be a carbon-based substrate, a non carbon-based substrate, or a combination of two or more thereof, where the catalytic substrate has an electron-accepting material adsorbed thereto. In one embodiment, the catalytic substrate comprises a metal free substrate having an electron-accepting material adsorbed thereto. In one embodiment, the electron-accepting material comprises a nitrogen-containing material such as an amino group, an ammonium group, or nitrogen-free electron accepting moietites. The catalytic substrates can be used to provide an electrode, such as a cathode, and are suitable for use in a variety of electrochemical devices.

In one aspect, the present invention provides an electrode comprising an electrode body; and a catalytic layer disposed on a surface of the electrode body, the catalytic layer comprising an array of carbon nanotubes or graphene sheets having an electron-accepting material adsorbed thereto.

In one embodiment, the electron accepting material is a cationic polyelectrolyte. In one embodiment, the cationic polyelectrolyte comprises an amino group, a quarternary ammonium group, or a combination of two or more thereof. In one embodiment the electron accepting material is chosen from a poly (diallylammonium chloride), poly(allylamine hydrochloride), methacryloxyethyltrimethyl ammonium chloride, acryloxyethyl dimethylbenzyl ammonium chloride, mefhacryloxyethyl dimethylbenzyl ammonium chloride, acryloxyethyltrimethyl ammonium chloride, or a combination of two or more thereof.

In one embodiment, the concentration of electron-accepting material adsorbed onto the carbon nanotube or graphene sheet, is about 50% or less by weight of the catalytic substrate.

In one embodiment, the concentration of electron-accepting material adsorbed onto the catalytic substrate is from about 5 to about 15%, in another embodiment from about 8 to about 12%, by weight of the catalytic substrate.

In one embodiment, the catalytic substrate is chosen from a carbon nanotube, a graphene sheet, a graphite sheet, other carbon materials, or a combination of two or more thereof. In one embodiment, the catalytic substrate comprises a plurality of carbon nanotubes chosen from nonaligned carbon nanotubes, aligned carbon nanotubes, or a combination thereof. In one embodiment, the carbon nanotubes in the individually have a length of from about 5 μm to about 150 μm and/or individually have an outer diameter of from about 1 nm to about 80 nm.

In one embodiment, a portion of the surface of the electrode body comprises glassy carbon, and the catalytic layer is disposed on the glassy carbon.

In one embodiment, the electrode is a cathode.

In one embodiment, the present invention provides an electrochemical device comprising an electrode comprising an electrode body; and a catalytic layer disposed on a surface of the electrode body, that catalytic layer comprising an array of carbon nanotubes or graphene sheets having an electron-accepting material adsorbed thereto. In one embodiment, the ectrochemical device is chosen from a fuel cell, a battery, and a biosensor.

In another aspect, the present invention provides a method of forming an electrode material comprising an array of carbon nanotubes or graphene sheets having an electron-accepting material adsorbed thereto, the method comprising (a) providing a carbon nanotube array disposed on a substrate; (b) coating the carbon nanotube array or graphene sheets with the electron-accepting; (c) drying the nanotube array or graphene sheets from (b) in air; (d) removing the substrate to provide a free-standing functionalized nanotube array; and (e) attaching the free standing functionalized nanotube array to an electrode body.

In one embodiment, the method comprises spin coating the electron-accepting material into the nanotube array or on the graphene sheets.

In another embodiment, the method comprises repeating steps (b) and (c) one or more times.

In one embodiment, the method comprises drying the nanotube array or graphene sheets comprises drying in air at a temperature of from about 4° C. to about 100° C.

In still another aspect, the present invention provides a fuel cell comprising a fuel cell body; an oxidant inlet configured to fluidly couple the fuel cell body to an oxidant source; a fuel inlet configured to fluidly couple the fuel cell body to a fuel source; an exhaust outlet; a fuel cell cathode fluidly coupled to the oxidant inlet; a fuel cell anode fluidly coupled to the fuel inlet and the exhaust outlet; at least one electrolyte configured to enable flow of ions between the fuel cell cathode and the fuel cell anode; an electrically insulating ion-permeable membrane disposed within the fuel cell body between the fuel cell cathode and the fuel cell anode, the electrically insulating membrane configured to prevent flow of electrons between the fuel cell anode and the fuel cell cathode through the electrolyte; and an external circuit isolated from the electrolyte and electrically coupling the fuel cell anode and the fuel cell cathode, wherein the fuel cell cathode comprises a cathode body electrically coupled to the external circuit; and a catalytic layer electrically coupled to the electrolyte and the cathode body, the catalytic layer comprising a plurality of functionalized carbon nanotubes, a funtionalized graphene sheet, a functionalized graphite, or a combination of two or more thereof, the functionalized nanotube, graphene sheet, or graphite sheet comprising an electron accepting material adsorbed to the carbon nanotubes or the graphene sheet.

### DESCRIPTION OF THE DRAWINGS

Aspects of the invention may be better understood by reference to the following detailed description taken in connection with the following illustrations, wherein:

FIG. 1 is a schematic illustration of an embodiment of an electrode comprising a catalytic layer of functionalized carbon nanotubes;

FIG. 2 is a schematic illustration of one embodiment of a method for preparing an electrode comprising a catalytic layer of functionalized carbon nanotubes;

FIG. 3 is a cross-sectional plan view of an embodiment of a fuel cell comprising a fuel cell cathode having a catalytic layer of functionalized carbon nanotubes;

FIG. 4A(a)-(d) are cyclic voltammograms of oxidation reduction reactions on non-functionalized nonaligned carbon nanotubes (CNT), aligned carbon nanotubes, PDDA functionalized nonaligned carbon nanotubes (PDDA-CNT), and PDDA functionalized aligned carbon nanotubes (PDDA-ACNT), respectively, in N₂ and O₂-saturated KOH;

FIG. 4B is a cyclic voltammogram of the oxygen reduction reaction for non-functionalized aligned and nonaligned carbon nanotubes, PDDA-CNT, and PDDA-ACNT in O₂-saturated KOH;

FIG. 4C is a linear sweep voltammogram of oxygen reduction reaction for non-functionalized aligned and nonaligned carbon nanotubes, PDDA-CNT, and PDDA-ACNT in O₂-saturated KOH;

FIG. 5 is a cyclic voltammogram of oxygen reduction on bare glassy electrodes and PDDA glassy electrodes;

FIG. 6 is a cyclic voltammogram of oxygen reduction of carbon nanotubes functionalized with PEI;

FIG. 7 is a graph of i-t chronoamperometric responses for Pt/C electrodes, PDDA-CNT/GC electrodes, and PDDA-ACNT/GC electrodes;

FIG. 8 is a graph of i-t chronoamperometric responses for Pt/C electrodes, PDDA-CNT/GC electrodes, and PDDA-ACNT/GC electrodes illustrating current density over time;

FIG. 9A-C are linear sweep voltammograms of the oxygen reduction reaction at different rotation rates for bare CNT, PDDA-CNT, and PDDA-ACNT, respectively; and

FIG. 9D is a graph of Koutechy-Levic (“K-L”) plots for the electrodes of FIGS. 9A-C;

FIG. 10(a) is a cyclic voltammogram for oxygen reduction reactions on a graphene electrode and a PDDA-graphene electrode in O₂-saturated KOH; FIG. 10(b) is a linear sweep voltammogram for oxygen reduction reactions on a grapheme electrode, a PDDA-graphene electrode and a Pt/C electrode in O₂-saturated KOH;

FIG. 11(a)-(b) shows linear sweep voltammograms for various different rotation rates for oxygen reduction at a graphene, electrode and a PDDA-graphene electrode, respectively, in an O₂-saturated KOH solution; FIG. 11(c)-(d) are K-L plots of ORR on the graphene and PDDA-graphene electrode, respectively; FIG. 11(e)-(f) show the dependence of the electron transfer number and the kinetic current density, respectively, on the potential for both the graphene and PDDA-graphene electrodes; FIG. 11(g)-(h) show the oxygen reduction reaction on the rotating ring disk electrode of a graphene electrode and a PDDA-graphene electrode, respectively;

FIG. 12(a)-(c) is a graph of the current-time (i-t) chronoamperometric responses for oxygen reduction reaction at the PDDA-graphene and Pt/C electrodes in an O₂-saturated KOH;

FIG. 13 illustrates TGA testing of PDDA-graphene samples with varying PDDA percentage;

FIG. 14(a) is a linear sweep voltammogram of ORR on the PDDA-graphene electrode with different PDDA percentage; FIG. 14(b) is a plot of onset potential and current density at −0.6V of oxygen reduction reaction on PDDA-graphene electrodes with different PDDA percentages; and

FIG. 15(a)-(c) illustrates the effects of the PDDA percentage in an embodiment of a PDDA-graphene electrocatalyst on the sensitivity (methanol tolerance), CO tolerance, and durability, respectively.

### DETAILED DESCRIPTION

While the present invention may be described with reference to various detailed embodiments described herein, the description of the embodiments is for illustrating aspects of the present invention and is not intended to limit the scope of the invention.

In one aspect, the technology relates to an electrocatalyst material comprising a functionalized catalytic substrate. The electrocatalyst comprises a catalytic layer with a functionalized catalytic substrate, having an electron-accepting material adsorbed thereto. The catalytic substrate is substantially metal free, and may be chosen from a carbon based or non-carbon based material, e.g., a conductive polymer. In one embodiment, the catalytic substrate is a carbon based material. Examples of suitable carbon-based materials include, but are not limited to, carbon nanotubes, graphene, graphite, and the like. In one embodiment, the catalytic substrate is substantially metal free and has a total metal concentration that it undetectable or untraceable. In another embodiment the catalytic substrate is substantially metal free and has a total metal concentration of less than about 5% by weight of the substrate; less than about 1% by weight of the substrate; less than 0.1% by weight of the substrate; less than 500 ppm; less than 100 ppm; less than 500 ppb; less than 100 ppb; less than 10 ppb. Here as elsewhere in the specification and claims, numerical values can be combined to form new and non-disclosed ranges.

In one embodiment, the catalytic substrate is formed from carbon nanotubes. The carbon nanotubes may be nonaligned carbon nanotubes, aligned carbon nanotubes (ACNT), or combinations thereof. The dimensions of the individual nanotubes of the catalytic layer may be chosen as desired for a particular application. In one embodiment, the nanotubes may individually be from about 5 μm to about 150 μm long and may have outer diameters of about 1 nm to about 80 nm. In one embodiment, the nanotubes may be about 8 μm long and may have an outer diameter of approximately 25 nm. The nanotube dimensions are not limited to those dimensions described above and are not intended to limit the catalytic layer of a cathode to any particular dimension. The furnace or vessel used to grow the nanotubes can be scaled up as desired to produce a catalytic layer that is considerably thicker or covers a much larger portion of the outer surface of a cathode body.

In one embodiment, the catalytic substrate comprises graphene or graphite sheets. As used herein, “graphene” refers to the atom-thick, two-dimensional layer of carbon atoms. A graphene sheet can comprise one or more graphene layers. A graphite sheet can comprise a plurality of graphene sheets. In one embodiment, the graphene sheets can have a layer number of from about 1 to about 100; from about 3 to about 50; even from about 10 to about 20. In one embodiment, the graphene sheets have a layer number of about 1 to about 3. In another embodiment, the graphene sheets have a layer number of about 3 to about 10. In another embodiment, the graphne sheets have a layer number of about 10 to about 100. In one embodiment, graphite sheets can have a thickness of from about 100 to about 1000. In another embodiment, the catalytic substrate comprises graphite particles.

The functionalized catalytic substrate comprises an electron-accepting material adsorbed to the catalytic substrate. The electron-accepting material may be chosen from any suitable material that may or may not contain positively charged moieties and that may be adsorbed onto the catalytic substrate. Examples of suitable materials include, but are not limited to, electrolyte chains containing positively charged moieties, polar materials, and the like. In one embodiment, the electron-accepting material comprises an electrolyte chain comprising positively charged nitrogen moieties. In another embodiment, the electron-accepting material comprises nitrogen-free electron-accepting moieties. The electrolyte may be provided as a polyelectrolyte. In one embodiment, the electron-accepting material comprises a cationic polyectrolyte. In one embodiment, the polyelectrolyte contains at least one of an amino group or an ammonium group. Useful cationic polyelectrolytes include, but are not limited to, polydiallyldimethyl ammonium chloride (PDDA), polyallylamine hydrochloride, and copolymers containing quaternary ammonium acrylic monomers, such as methacryloxyethyltrimethyl ammonium chloride, acryloxyethyl dimethylbenzyl ammonium chloride, methacryloxyethyl dimethylbenzyl ammonium chloride and acryloxyethyltrimethyl ammonium chloride, or combinations of two or more thereof A particularly suitable electron accepting material is poly(diallyldimethylammonium chloride) (PDDA).

In one embodiment, the concentration of electron-accepting material adsorbed onto the catalytic substrate may be less than about 50 wt % by weight of the catalytic substrate. In another embodiment, the electrocatalyst comprises from about 5 wt % to about 50 wt %; about 8 wt % to about 40 wt %; even about 10 wt % to about 30 wt % of the electron-accepting material adsorbed onto the catalytic substrate. In one embodiment, the electrocatalyst comprises from about 5 wt % to about 15 wt % of the electron-accepting material adsorbed onto the catalytic substrate. In a further embodiment, the electrocatalyst comprises from about 8 wt % to about 12 wt % of electron-accepting material adsorbed onto the catalytic substrate. Here as elsewhere in the specification and claims, numerical values can be combined to form new or non-disclosed ranges.

The functionalized electrocatalyst can be formed in any suitable manner to adsorb the electron-accepting material onto the catalytic substrate. In one embodiment, the electrocatalyst can be formed by immersing or dispersing the catalytic substrate material into a solution of the electron-accepting material and spincoating the electron-accepting material to provide a catalytic substrate with electron-accepting material adsorbed to it. Such a method may be particularly suitable for forming functionalized carbon nanotubes. In another embodiment, graphene sheets having an electron-accepting material thereto are formed by reducing graphene oxide in the presence of a reducing agent and the electron-accepting material. In one embodiment, the reducing agent can be chosen so as to avoid the introduction of nitrogen atoms into the graphene plane. Example of such suitable reducing agents include, but are not limited to, sodium borohydride (NaBH₄), sodium naphthalenide, sodium anthracenide, sodium benzopherane, sodium acenaphthylenide, etc. In another embodiment, a reducing agent that allows for the introduction of nitrogen atoms into the graphene plane can be used. An example of such a reducing agent is hydrazine. Nitrogen doped carbon can exhibit some oxygen reduction activity, and using a reducing agent to incorporate nitrogen atoms into the carbon structure could provide a hybrid catalyst having oxygen reduction activity from both the nitrogen doped carbon atoms and the electron-accepting material adsorbed to the catalytic substrate.

The electrocatalyst is suitable for use in connection with an electrode of any electrochemical cell used in a variety of fields, including, but not limited to, electrodes for use in a fuel cell, a meal-air battery, etc. In one embodiment, the electrocatalyst is particularly suitable to catalyze the cathode side half-reaction (i.e., the ORR) in an electrochemical cell.

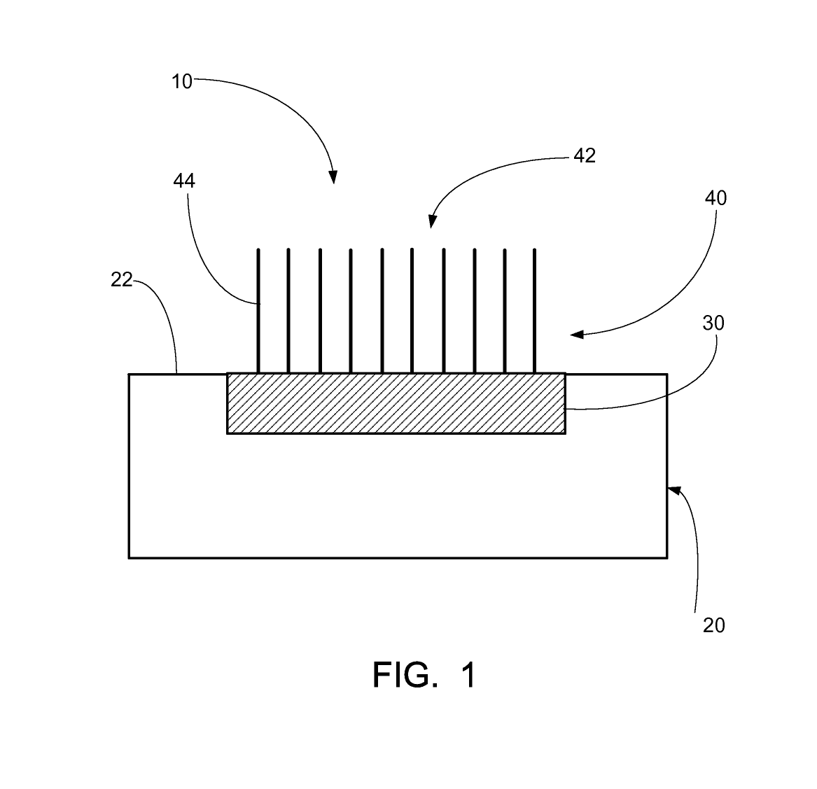

Referring to FIG. 1, an example embodiment of a cathode 10 comprising an electrocatalyst is provided. The cathode 10 may comprise a cathode body 20 with an outer surface 22. The shape of the cathode body 20 is not limited and may have any shape, cross-section, or configuration and may be made of any suitable material as desired for a particular purpose or intended use. In one embodiment, the cathode body 20 may be a solid electric conductor, such as a metal, a conductive polymer, or glassy carbon. In another embodiment, the cathode body 20 may comprise a conductive or non-conductive shell (not shown) surrounding an electrically conductive core (not shown). In the embodiment shown in FIG. 1, the cathode 10 comprises a contact portion 30 configured as a glassy carbon insert within the cathode body 20 and exposed to form part of the outer surface 22 of the cathode body 20. The contact portion 30 may be electrically coupled to the cathode body 20 itself or, if the cathode body is non-conductive, to a conductor (not shown) extending through the cathode body 20. In another embodiment (not shown), the contact portion 30 may be configured as a coating of glassy carbon covering up to a substantial entirety of the outer surface 22 of the cathode body 20.

The cathode 10 further comprises a catalytic layer 40 attached to the contact portion 30 of the cathode body 20. (FIG. 1) The catalytic layer comprises a nanotube array 42 attached to a portion of the outer surface 22 of the cathode body 20, in particular to the contact portion 30. It will be appreciated that the nanotube array 42 may be attached to a contact portion 30 covering any amount of the cathode body 20 as desired for a particular application. For example, the nanotube array 42 may cover only a tip of a cylindrical cathode body, a surface feature of a flat cathode body such as a plate, or any amount up to substantially the entire surface of a cathode body of any desired shape.

The nanotube array 42 comprises a plurality of functionalized carbon nanotubes 44 having an electron-accepting material absorbed thereto. (FIG. 1.) Because FIG. 1 shows only a cross-sectional plan view, it will be understood that when viewed from above down the rotational axes of the nanotubes, the plurality of functionalized carbon nanotubes are arranged as an array of any energetically favorable configuration in the two dimensions of the outer surface 22 of the cathode body 20. As shown in FIG. 1, the nanotube array 42 is provided as an array of aligned carbon nanotubes. As described in this specification, however, a nanotube array may be provided by nanoaligned nanotubes or a combination of aligned and nonaligned nanotubes.

Optionally, the nanotube array may be supported by a binder material or binder layer (not shown). A binder should be electrically conductive and may comprise any electrically conductive material suitable for supporting the functionalized carbon nanotube array to the cathode body 20. In one embodiment, the binder layer may comprise a conductive polymer composite such as, for example, a polystyrene mixed with conducting carbon nanotubes and/or any other conducting components. The term “polystyrene” is not intended to be limited to any one type of composition and may include homopolymers and copolymers of styrene and may refer to any polymer comprising styrene repeating units or other monomer units, without regard to molecular size, stereochemistry, or the presence of additional polymer units.

The binder layer may comprise non-aligned carbon nanotubes that form a composite with a conductive or nonconductive polymer. In one embodiment, the binder layer may comprise a composite of a polystyrene and nonaligned carbon nanotubes. The nonaligned carbon nanotubes may comprise a graphitic structure consisting of carbon atoms, or the nonaligned carbon nanotubes may be functionalized. Without being bound to any particular theory, the presence of nonaligned carbon nanotubes within a conductive polymer-nanotube composite may stabilize the catalytic layer 40 and strengthen the bonding between the binder layer and the catalytic layer 40, such as through van der Waals interactions.

While the embodiment of FIG. 1 is illustrated with respect to an aligned nanotube array, it will be appreciated that the catalytic layer 40 can comprise non-aligned carbon nanotubes, a graphene sheet, a graphite sheet, or a combination of two or more thereof.

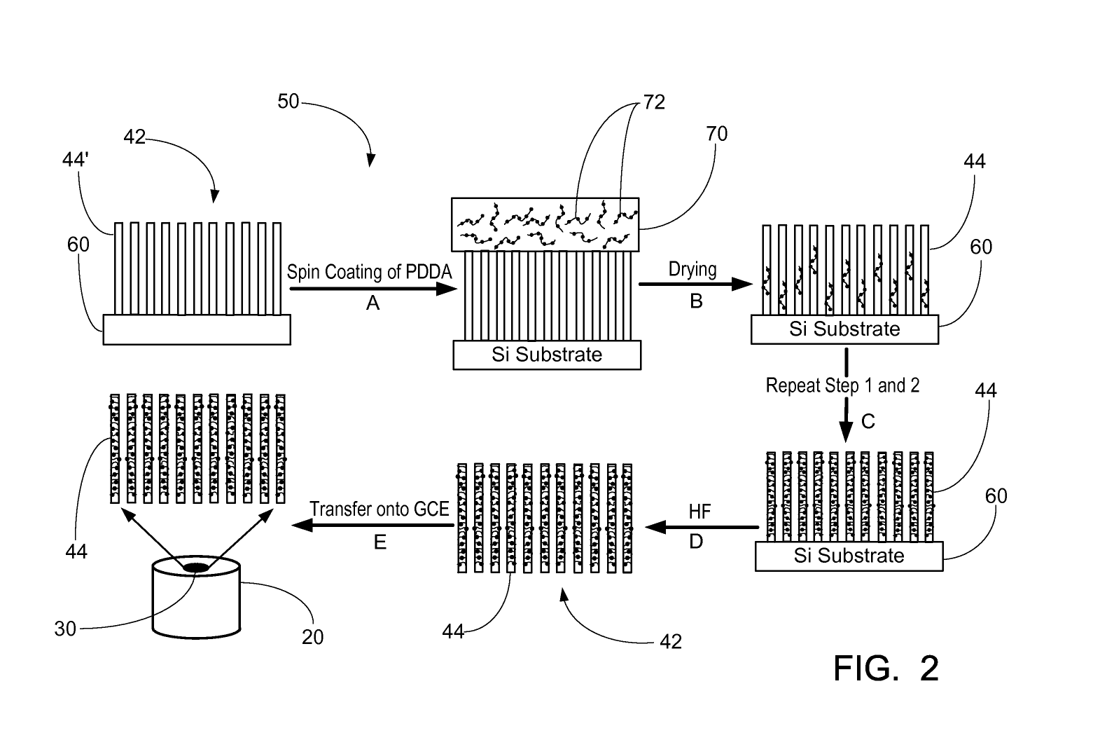

FIG. 2 illustrates an embodiment of a method for producing an electrode having an electrocatalyst comprising a functionalized catalytic substrate in accordance with the present technology. Method 50 may comprise first providing a substrate 60 comprising an array 42 of non-functionalized carbon nanotubes 44′ bound to a surface of the substrate. The substrate 60 may comprise any material suited for growth/transfer of carbon nanotubes thereon. In one embodiment, the substrate 60 may comprise a silica (SiO₂) substrate, such as a quartz plate, or a silicon wafer with a native or prepared layer of SiO₂ thereon. The electrode preparation described above is merely an example of one embodiment, and is not intended to limit the specific materials used to form the electrode. For example, the material used to support the functionalized catalyst materials of the invention can be any suitable support material such as silica, or some other surface or support material (including, but not limited to, membrane materials that can be used in a fuel cell, etc.).

The array of carbon nanotubes may be deposited by any suitable method know in the art to provide an array of nonaligned or aligned carbon nanotubes. For example, a nanotube array may be provided by injecting a toluene/ferrocene mixture in a quartz tube furnace under an Ar/H₂ atmosphere and heating, or by pyrolyzing a hydrocarbon or a metalorganic compound in the presence of the substrate 60. In example embodiments, the metalorganic compound may be a sandwich compound such as, for example, ferrocene, or a nitrogen-containing metal heterocycle such as, for example, an iron(II) phthalocyanine (FePc). Residual metal particles derived from the metalorganic compound optionally may be removed, such as by electrochemical oxidation. Removal of residual metal particles produces metal-free ORR catalysts the fuel cell cathode fabricated according to the above method.

At Step A, the nanotubes 44′ are functionalized with an electron-accepting material by spin coating the electron-accepting material into the nanotube array. In step B, the nanotube array that is coated with the electron-accepting material is dried at a temperature of about 4 to about 100° C. in air to cause a controlled infiltration of the electron-accepting material into the nanotube array. At Step C, Steps A and B are repeated one or more times to infiltrate the electron-accepting material into the forest of carbon nanotubes.

At Step D, the Si-supported, functionalized nanotube array is immersed into an aqueous solution of HF to peel the functionalized nanotube array away off the silica substrate and provide a free standing array of functionalized carbon nanotubes 44. The array may be washed as desired to remove any unadsorbed electron-accepting material.

At Step E, the free-standing nanotube array may be attached to a contact portion 30 of an outer surface 22 of a cathode body 20 to form the cathode 10 (FIG. 1). In one embodiment, the contact portion 30 may comprise glassy carbon. In another embodiment, the contact portion 30 may be of any desirable size or configuration, and may even be provided such that it covers substantially the entire outer surface 22 of the cathode body 20. The nanotube array 42 may be attached to the contact portion 30 by contacting the nanotubes 44 of the nanotube array 42 to the contact portion 30. The nanotubes may be attached to the contact portion 30 in any manner suitable to establish a conductive connection between the nanotube array 42 and the cathode body 20 at the contact portion 30.

In a further step (not shown), the catalytic layer provided by the nanotube array of the fuel cell cathode 10 may be purified. In one example, the purification may be carried out by electrochemically oxidizing the electrode. The electrochemical oxidation of the fuel cell cathode 10 may be carried out, for example, in an aqueous solution of H₂SO₄ (0.5 M) at a potential of 1.7 V (vs. Ag/AgCl) for about 300 s.

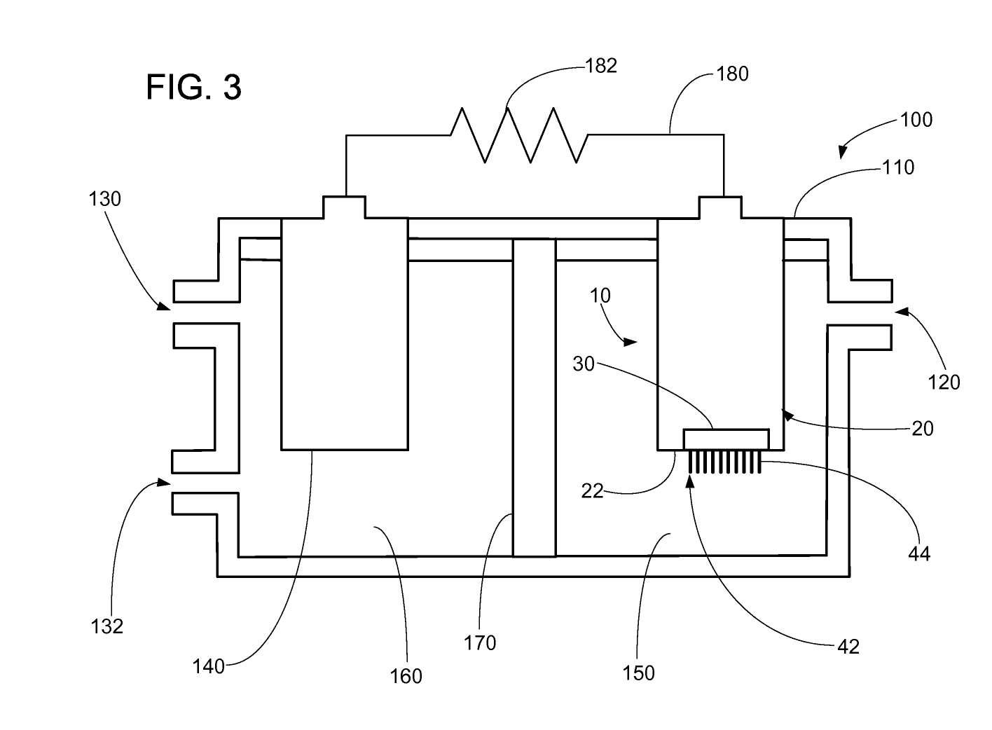

A cathode comprising an electrocatalyst in accordance with the present technology may be used in an electrochemical device where oxygen reduction reactions occur and an electrocatalyst may be used to facilitate such reactions. FIG. 3 illustrates an embodiment of a fuel cell 100 incorporating a fuel cell cathode 10 comprising an electrocatalyst in accordance with the present technology. The fuel cell 100 comprises a fuel cell body 110. The fuel cell body 110 may be any shape and may be formed of any material suitable for enclosing the electrochemical components of the fuel cell 100 itself. The fuel cell body 110 comprises an oxidant inlet 120 configured to fluidly couple the fuel cell body 110 to an oxidant source (not shown). The oxidant source may be any vessel suited to a desired application such as, for example, an oxygen tank of any shape, size, or configuration. The fuel cell body further comprises a fuel inlet 130 configured to fluidly couple the fuel cell body 110 to a fuel source (not shown). The fuel source also may be any vessel suited to a desired application. Examples of fuels suitable for introduction through the fuel inlet 130 include without limitation gas streams or liquid solutions comprising hydrogen, methanol, glucose, formaldehyde, or mixtures thereof. Thus, in example embodiments, the fuel cell 100 may be configured as a hydrogen fuel cell, as a glucose fuel cell, as a methanol fuel cell, or as a formaldehyde fuel cell.

The fuel cell body 110 further comprises an exhaust outlet 132, through which waste products such as water can be expelled from the fuel cell 100. The sizes, shapes, and configurations of the oxidant inlet 120, the fuel inlet 130, and the exhaust outlet 132 are not limited and may be selected for a particular application or intended use. Each may be relocated anywhere on the fuel cell body 110, provided the applicable oxidant or fuel is still supplied to the fuel cell body 110 and the waste products are expelled from the fuel cell body 110.

The fuel cell 100 further comprises a fuel cell cathode 10 fluidly coupled to the oxidant inlet 120. A fuel cell anode 140 is fluidly coupled to the fuel inlet 130 and the exhaust outlet 132. Within the fuel cell body 110 and between the fuel cell cathode 10 and the fuel cell anode 140, a cathode electrolyte 150 and an anode electrolyte 160 are configured to permit flow of ions between the fuel cell cathode 10 and the fuel cell anode 140. Example configurations include, but are not limited to, at least partially immersing the fuel cell cathode 10 and the fuel cell anode 140 in liquid electrolytes (as shown), placing the fuel cell cathode 10 and the fuel cell anode 140 in physical contact with solid electrolytes (not shown), or both. Thus, the cathode electrolyte 150 and the anode electrolyte 160 may be liquids or solids and may have the same composition or different chemical compositions. In one example embodiment, both the cathode electrolyte 150 and the anode electrolyte 160 may contain hydroxyl ions, such that the fuel cell 100 as a whole would operate as an alkaline fuel cell.

An electrically insulating ion-permeable membrane 170 may be disposed within the fuel cell body 110 between the fuel cell cathode 10 and the fuel cell anode 140. The fuel cell anode 140 may comprise any suitable material known in the art for to be effective at reducing an selected fuel (e.g., hydrogen), and the fuel cell anode 140 may be coated with a catalyst layer (not shown) selected from among catalysts effective for catalyzing the reduction of the fuel. It will be understood that the sizes, shapes, and configurations of the fuel cell cathode 10 and the fuel cell anode 140 are not limited to those shown in FIG. 3, but that the example embodiment is meant to depict the interrelationships of the various components of the fuel cell 100. The electrically insulating ion-permeable membrane 170 is configured to prevent the flow of electrons between the fuel cell anode 140 and the fuel cell cathode 10 through one or both of the cathode electrolyte 150 and the anode electrolyte 160. Nevertheless, the ions involved in the selected chemistry of the fuel cell 100 can flow freely through the electrically insulating ion-permeable membrane 170. As such, the electrically insulating ion-permeable membrane 170 may be selected from any type of membrane suitable for fuel cells generally (e.g., Nafion), in view of technical needs of the particular fuel cell 100. In one example, the electrically insulating ion-permeable membrane 170 is permeable to hydroxyl ions. It is foreseeable within the scope of these embodiments that while a variety of fuel cell configurations may be possible, the electrically-insulating ion-permeable membrane 170 is entirely optional.

The fuel cell 100 further comprises an external circuit 180 physically isolated from the cathode electrolyte 150 and the anode electrolyte 160. The external circuit 180 electrically couples the fuel cell anode 140 and the fuel cell cathode 10. The external circuit 180 may comprise an electrical load 182. In example embodiments, the electrical load 182 may comprise one or more electrical or mechanical device that can be powered with electricity generated by the fuel cell 100. In a further example embodiment, the electrical load 182 may comprise an electrical storage system (not shown), such as an electric battery.

The fuel cell cathode 10 comprises a cathode body 20 electrically coupled to the external circuit 180. The cathode body 20 has an outer surface 22. The cathode body 20 may have any desired shape, cross-section, or configuration and may be made of any suitable material. In one embodiment, the cathode body 20 may be a solid electric conductor, such as a metal, a conductive polymer, or glassy carbon. In another embodiment, the cathode body 20 may comprise a conductive or non-conductive shell (not shown) surrounding an electrically conductive core (not shown). In the embodiment shown in FIG. 3, the fuel cell cathode 10 comprises a contact portion 30 configured as a glassy carbon insert within the cathode body 20 and forming a portion of the outer surface 22 of the cathode body 20. The contact portion 30 may be electrically coupled to the cathode body 20 itself or, if the cathode body is non-conductive, to a conductor (not shown) extending through the cathode body 20. In another embodiment not shown, the contact portion 30 may be configured as a coating of glassy carbon covering up to a substantial entirety of the outer surface 22 of the cathode body 20 or, alternatively, up to a substantial entirety of the portion of the cathode body 20 that is in physical contact with the cathode electrolyte 150.

The fuel cell cathode 10 further comprises a nanotube array 42 attached to the contact portion 30 of the cathode body 20. FIG. 3 shows by means of illustration, not of limitation, that the nanotube array 42 is attached to only a portion of the outer surface of the cathode body 20, in particular to the contact portion 30 configured in FIG. 3 as a glassy carbon insert. As suitable for the desired application, the nanotube array 42 may be attached to and cover any amount of the cathode body 20. While FIG. 3 depicts a nanotube array covering only a tip of the cathode body 20, shown as cylindrical, the nanotube array may be provided to cover, for example, a surface feature of a flat cathode body, or any amount up to substantially the entire surface of a cathode body of any desired shape. In other embodiments (not shown), the fuel cell cathode 10 may comprise multiple nanotube arrays, which may be contiguous or non-contiguous.

The nanotube array 42 provides a catalytic layer 40 defined by a plurality of carbon nanotubes. In one embodiment, the individual carbon nanotubes may have lengths of approximately 5 μm to approximately 150 μm and outer diameters of approximately 1 nm to approximately 80 nm.

While the electrocatalyst material in connection with the embodiment depicted with respect to FIG. 3 is described in terms of an electrocatalyst comprising functionalized aligned carbon nanotubes, it will be appreciated that the electrocatalyst material could be provided using another suitable catalytic substrate such as, for example, nonaligned carbon nanotubes, graphite materials, graphene materials, and non-organic catalytic substrates, or a combination of two or more thereof. Further, while the embodiment described with respect to FIG. 3 is described in terms of a fuel cell, it will be appreciated that an electrocatalyst material in accordance with the disclosed technology and an electrode employing such material may be used in almost any electrochemical device where oxygen reduction reactions are carried out and where an electrocatalyst material may be suitably employed to catalyze such reactions. For example, the electrocatalyst material may be used in electrochemical devices and applications including, but not limited to, fuel cells, batteries (e.g., lithium batteries), organic solar cells, supercapacitors, hydrogen generators, biosensors, desalination operations, petrochemical refining, catalytic converters, etc.

An electrocatalyst material comprising a functionalized catalytic substrate comprising an electron-accepting material adsorbed thereto provides an electrocatalyst material that performs at least as well as conventional Pt/C catalysts. The present electrocatalyst materials, however, exhibit better fuel selectivity (being more compatible with a broader range of fuels), better resistance to poisoning effects (such as by, for example, carbon monoxide), and are more durable than conventional Pt/C catalysts. Additionally, the cost to manufacture the present electrocatalyst material is significantly cheaper than conventional Pt/C catalysts and may be orders of magnitude cheaper (on the order of 100× less expensive) than Pt/C catalysts.

### EXAMPLES

Aspects of the invention may be further understood with respect to the following Examples. The Examples may illustrate various embodiments of the invention and are not intended to limit the invention in any manner. Functionalized Carbon Nanotubes

Materials. Vertically-aligned carbon nanotubes (ACNTs) were prepared by preheating a Si wafer in a quartz tube furnace under Ar/H₂ at 760° C. for 5 min, followed by continuously injecting toluene/ferrocene (99/l wt/wt, 3 ml) for 10 min under a combined flow of Ar (150 SCCM)/H₂ (15 SCCM) at 760° C. Commercially available nonaligned carbon nanotubes (CNTs), synthesized by pyrolysis of propylene using an iron-based catalyst. The as-received multiwall carbon nanotube (MWNT) was refluxed with vigorous stirring in hydrochloric acid (37% HCl) for 12 hrs. After cooling to room temperature, the acidic solution was poured into ice water. The aqueous black suspension was filtered through 0.45 μof nylon membrane and washed repeatedly with water. Finally, purified MWNT was dried under vacuum overnight. Before conducting measurements on the materials, the electrocatalyst was purified by electrochemical purification by repeating the potentiodynamic sweeping from +0.2 V to −1.2 V in a nitrogen-saturated 0.1 M KOH electrolyte solution until a steady voltammogram curve was obtained. Commercial Pt/C electrocatalysts (Vulcan XC-72R) were from E-TEK Division, PEMEAS Fuel Cell technologies. All other chemicals were from Sigma-Aldrich and used without any further purification, unless stated otherwise.

Electrode preparation. PDDA functionalized carbon nanotubes were prepared as follows: 100 mg of CNTs were suspended in 400 ml DI water by ultrasonication in the presence of PDDA (at 5 wt % of the suspension) to provide a stable CNT dispersion. The suspension was then filtrated and washed with DI-water several times followed by drying in vacuum oven at 70° C. for 24 hours. Carbon nanotube suspensions, with or without functionalization by PDDA, in ethanol (1 mg/ml) were then prepared by introducing a predetermined amount of appropriate CNTs in the pure solvent under sonication. The procedure used to prepare the PDDA-functionalized carbon nanotube electrodes is similar to that illustrated and described in FIG. 2. The PDDA solution (0.02 wt %) was spin-coated on a Si-supported ACNT array (Step A), followed by drying to infiltrate PDDA polymer chains into the ACNT forest (Step B). The process was repeated for several times (Step C). Thereafter, the Si-supported ACNT was immersed into an aqueous solution of HF (1/6 v/v) to peel off the PDDA-functionalized ACNT array, followed by washing with DI water to remove unadsorbed PDDA residues, if any (Step D in FIG. 2). The free-standing PDDA-ACNT was then transferred onto the surface of a GCE, followed by fixing with 5 μl of Nafion solution (0.05 wt % in isoproponal) (step E in FIG. 2). The as-prepared CNT, PDDA-CNT and PDDA-ACNT electrodes were then electrochemically purified according to the previously reported procedure.

For electrode preparation, 10 μl of the carbon nanotube suspension was dropped onto the surface of a pre-polished glassy carbon electrode (GCE), followed by dropping 5 μl Nafion solution in isoproponal (0.5 wt %) as a binder.

Characterization. Electrochemical measurements were performed using a computer-controlled potentiostat (CHI 760C, CH Instrument, USA) with a typical three-electrode cell. A platinum wire was used as counter electrode and saturated calomel electrode (SCE) as reference electrode. All the experiments were conducted at room temperature (25±1° C.).

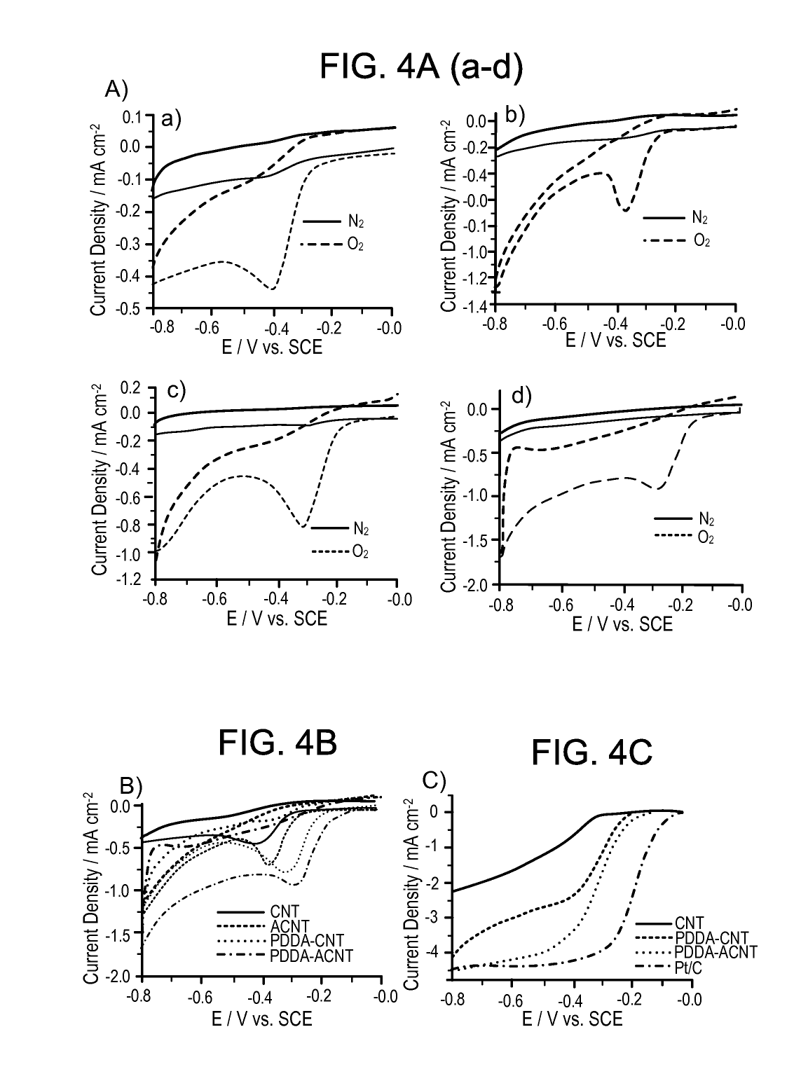

FIGS. 4A(a-d) shows cyclic voltammograms (CVs) of oxygen reduction in O₂- or N₂-saturated 0.1 M KOH solutions at bare CNT electrodes, bare ACNT electrodes, PDDA-CNT electrodes, and PDDA-ACNT electrodes, respectively, at a constant active mass loading (0.01 mg) are shown in FIG. 4. FIG. 4A shows the ORR peaks for all of the nanotube electrodes in the O₂-saturated and N₂-saturated, 0.1 M KOH solution. For the bare CNT electrode, the onset potential of ORR is at −0.29 V (versus SCE) with a single cathodic reduction peak around −0.4 V (versus SCE, FIGS. 4A(a)&4B), indicating a two-electron (2 e) process for reduction of O₂ to peroxide (HO₂⁻ in 0.1 M KOH). Upon functionalization of the CNT with PDDA, both the onset potential and the reduction peak potential of ORR shifted positively to around −0.12 V and −0.30 V, respectively, with a concomitant increase in the peak current density (FIG. 4B). These results clearly indicate a significant enhancement in the ORR electrocatalytic activity for the PDDA-adsorbed CNTs (i.e., PDDA-CNT). Compared with the PDDA-CNT electrode, the PDDA-ACNT electrode shows even a more positive shift in both the onset potential (−0.07 V) and the peak potential (−0.28 V) with a more pronounced increase in the current density. Without being bound to any particular theory, the charge-transfer effect and the alignment structure may play a role in the ORR process by facilitating the electrolyte diffusion, as previously demonstrated for the VA-NCNT electrode.

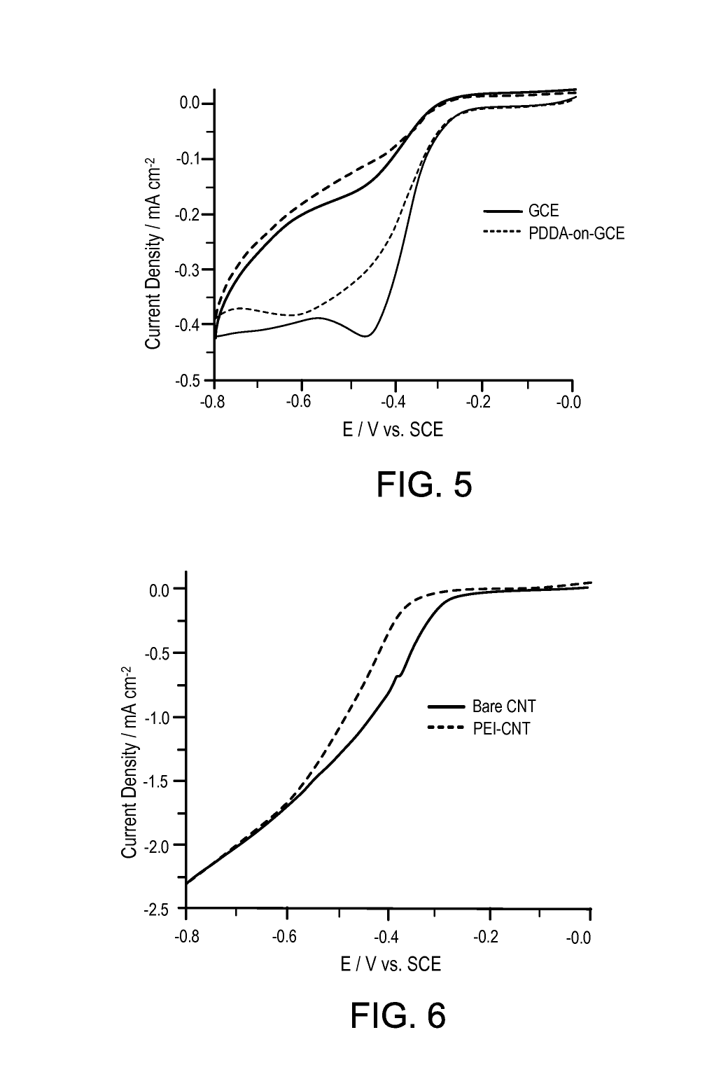

As a control, the ORR test was performed on a solution-cast PDDA/GC electrode (PDDA/GCE) and bare GC electrode (GCE) (FIG. 5), showing no ORR activity. FIG. 5 illustrates that the onset potential of the oxygen reduction reaction on bare GCE and PDDA-GCE are at the same position, which indicates that PDDA has no electrocatalytic activity toward ORR.

In view of the fact that polyethyleneimine (PEI) has been widely used as an electron donor to modify CNTs for various device applications (e.g., FETs), CNTs were functionalized with PEI, and the ORR electrocatalytic activity of the PEI-CNTs was compared with the activity of the bare CNT electrode (FIG. 6). The ORR onset potential at the PEI-CNT electrode shifted negatively from that of the bare CNT electrode, indicating a reduced ORR electrocatalytic activity for the CNTs after being functionalized with the electron-donating PEI chains.

Linear sweep voltammetry (LSV) measurements were carried out on a rotating disk electrode (RDE) for each of the electrode materials, including the CNT-based and commercial Pt/C electrocatalysts, in O₂-saturated 0.1 M KOH at a scan rate of 10 mV s⁻¹ and a rotation rate of 1600 rpm. As can be seen in FIG. 4C, the ORR at the bare CNT electrode commenced around −0.24 V (onset potential), followed by a continuous increase in the current density with no current plateau. The ORR onset potential at the PDDA-CNT electrode significantly shifted positively to −0.14 V and the limiting diffusion current at −0.4 V became about 3 times stronger with a relatively wide plateau in respect to the bare CNT electrode. Compared to both the PDDA-CNT and bare CNT electrodes, the strongest limiting diffusion current with a very wide current plateau was observed for ORR at the PDDA-ACNT electrode due, most probably, to an efficient four-electron pathway. The ORR current density at −0.4 V at the PDDA-ACNT electrode is 1.5 and 4.5 times that at the PDDA-CNT and bare CNT electrode, respectively, indicating that the combined effects of the PDDA adsorption and the aligned CNT structure may be responsible for the high ORR electrocatalytic activity observed for the PDDA-ACNT electrode. Although the onset potential of ORR on PDDA-ACNT (−0.09 V) is still lower than that of the Pt/C electrode, its limiting diffusion current density is close to that of the Pt/C catalyst.

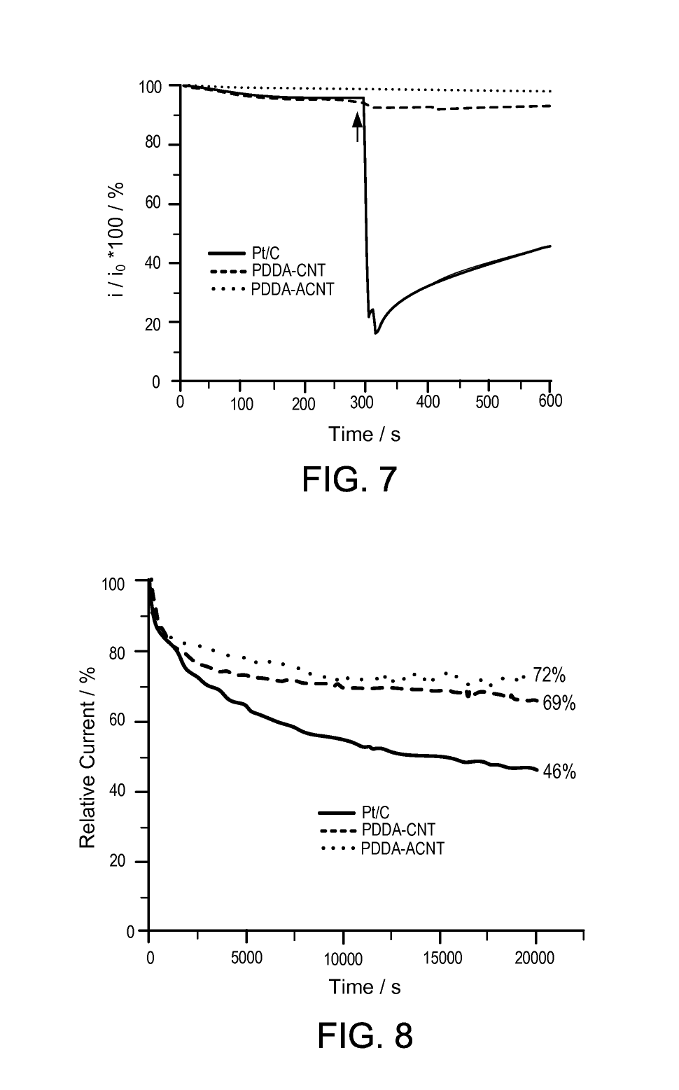

To examine the possible crossover effect in the presence of other fuel molecules (e.g., methanol) along with selectivity and tolerance of those molecules, the current-time (i-t) chronoamperometric responses for ORR at the PDDA-CNT and PDDA-ACNT electrodes were measured and compared to the chronoamperometric response for a Pt/C catalyst. As shown in FIG. 7, the Pt/C catalyst shows a sharp decrease in current upon the addition of 3.0 M methanol, while the amperometric responses from the PDDA-CNT and PDDA-ACNT electrodes remained unchanged even after the addition of methanol. Thus, the PDDA-functionalized CNT electrocatalysts have a higher selectivity toward ORR and better methanol tolerance than the commercial Pt/C electrode.

The durability of the PDDA-CNT, PDDA-ACNT, and the commercial Pt/C electrodes for ORR was also evaluated via a chronoamperometric method at −0.25 V in O₂-saturated 0.1 M KOH at a rotation rate of 1600 rpm. As illustrated in FIG. 8, the current density loss on PDDA-CNT and PDDA-ACNT is much less than that on Pt/C after continuous reaction for 20,000 seconds, and then the i-t chronoamperometric responses for the PDDA-CNT and PDDA-ACNT electrodes seem to level off, indicating that the PDDA-adsorbed nanotube electrocatalysts are more stable than the commercial Pt/C electrode.

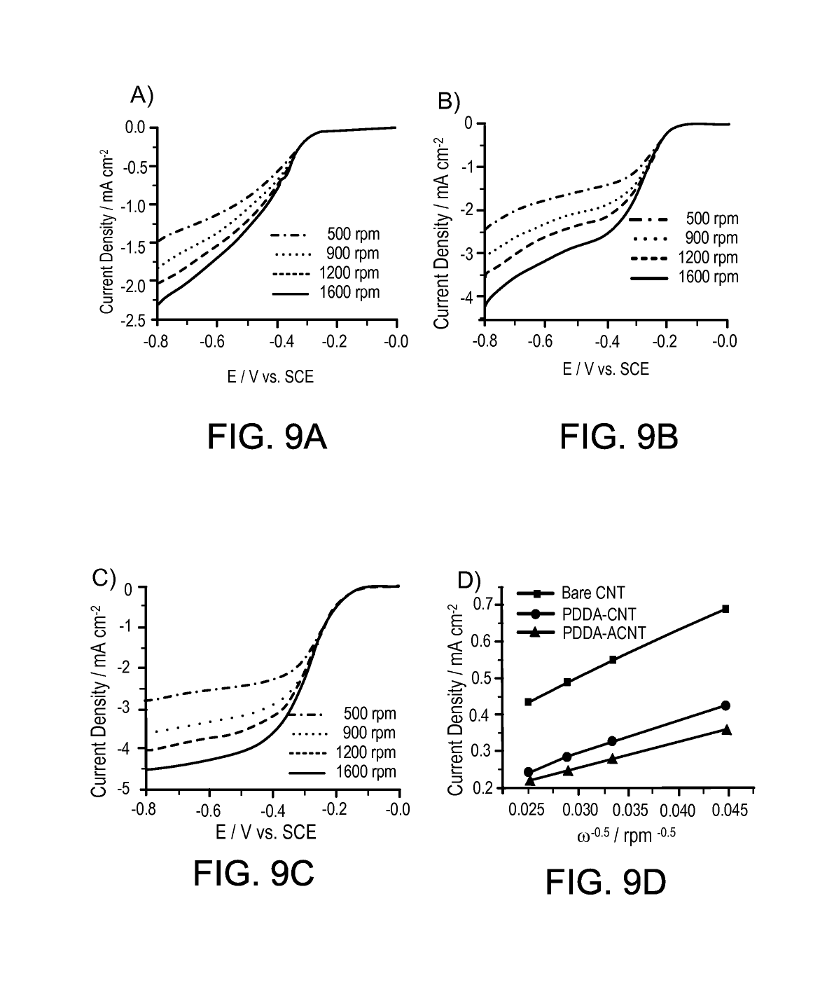

RDE voltammetry measurements were also carried out to evaluate the ORR performance of the CNT electrodes before and after adsorption with PDDA. FIGS. 9A-C show RDE current-potential curves at different rotation rates for a bare CNT electrode, a PDDA-CNT electrode, and a PDDA-ACNT electrode, respectively. As can be seen, the limiting current density increases with increasing rotation rate. Once again, the limiting current densities obtained from the PDDA-ACNT electrode are higher than those of all bare CNT and PDDA-CNT electrode at a constant rotation rate.

FIG. 9D illustrates Koutechy-Levich (K-L) plots, for the electrodes of FIG. 9A-C. As shown in FIG. 9D, a linear relationship between j⁻¹ and ω^{-0.5} was observed for all the three CNT-based electrodes at -0.8 V. The numbers of electrons transferred per O₂ molecule (n) were calculated from the slope of the K-L plots to be 2.21, 3.08, and 3.72 for the bare CNT, PDDA-CNT, and PDDA-ACNT electrode, respectively. While the electron transfer number (2.21) of ORR at the bare CNT electrode is close to the classical two-electron process, as is the case for many other carbon-based electrode materials, the corresponding number of 3.72 for the PDDA-ACNT electrode indicates an efficient four-electron process similar to the Pt/C electrode. On the other hand, the electron transfer number of 3.08, which lies between the two-electron and four-electron processes, for the PDDA-CNT electrode suggests that the oxygen reduction on PDDA-CNT electrocatalysts may proceed by a co-existing pathway involving both the two-electron and four-electron transfers.

The above demonstrates that polyelectrolyte functionalized carbon nanotubes, either in an aligned or nonaligned form, could act as metal-free electrocatalysts for ORR. PDDA adsorbed vertically-aligned CNT electrodes appear to possess remarkable electrocatalytic properties for ORR, similar to that of commercially available Pt/C electrodes but provide better fuel selectivity and/or long-term durability.

Functionalized Graphene Sheets

Synthesis of graphene oxide. Graphene oxide (GO) was synthesized from natural graphite powder by adding 0.9 g of graphite powder into a mixture of 7.2 mL of 98% H₂SO₄, 1.5 g K₂5₂O₈, and 1.5 g of P₂O₅. The solution was kept at 80° C. for 4.5 hours, followed by thorough washing with water. Thereafter, the as-treated graphite was put into a 250 mL beaker, to which 0.5 g of NaNO₃ and 23 mL of H₂SO₄ (98%) were then added while keeping the beaker in the ice bath. Subsequently, 3 g of KMnO₄ was added slowly. After 5 min, the ice bath was removed and the solution was heated up to and kept at 35° C. under vigorous stirring for 2 hours, followed by the slow addition of 46 mL of water. Finally, 40 mL of water and 5 mL H₂O₂ was added, followed by water washing and filtration. The exfoliation of graphene oxide was then performed by ultrasonication (Fisher-Scientific Mechanical Cleaner FS110, 50/60 Hz, 185 w).

Synthesis of PDDA functionalized/adsorbed graphene. PDDA functionalized/adsorbed graphene (PDDA-graphene) was prepared by sodiumborohydride (NaBH₄) reduction of GO in the presence of PDDA. Briefly, (100 mg) of GO was loaded in a 250-mL round-bottom flask, followed by the addition of 100 mL PDDA (0.5 wt %) in water to produce an inhomogeneous yellow-brown dispersion. This dispersion was sonicated until it became clear with no visible particulate and kept under stirring overnight. Thereafter, 100 mg NaBH₄ was added and the solution was stirred for 30 min, followed by heating in an oil bath at 130° C. equipped with a water-cooling condenser for 3 hours to produce a homogeneous black suspension. The final product (PDDA-graphene) was collected through filtration and dried in a vacuum oven for 24 hours.

Synthesis of Non-functionalized Graphene. Non funtionalized grapheme was obtained using the above procedure for the PDDA functionalized grapheme except that the synthesis reaction is carried out in the absence of PDDA.

The reduction of the GO to graphene and the functionalization thereof can be monitored by FTIR spectroscopy. GO shows a strong peak at around 1630 cm⁻¹ from the aromatic C═C along with C═O stretching at 1720 cm⁻¹, carboxyl at 1415 cm⁻¹, and epoxy at around 1226 cm⁻¹. The reduction of GO is evidenced by a dramatic decrease in the peaks at 1720 cm⁻¹, 1415 cm⁻¹, and 1226 cm⁻¹. Functionalization with PDDA is reflected by new peaks at 850 cm⁻¹ and 1505 cm⁻¹, which can be attributed to the N—C bond from adsorbed PDDA.

Reduction can also be observed by thermogravimetric analysis. GO has a poor thermal stability and low onset temperature for pyrolysis of the labile oxygen-containing functional groups over the range of 180-300° C.

The reduction of GO and functionalization with PDDA can also be elucidated by X-ray photoelectron spectroscopic (XPS) measurements. The O/C atomic ratio significantly decreased upon the NaBH₄ reduction. Subsequent PDDA functionalization/adsorption caused further decrease in the O/C atomic ratio, which was accompanied by the appearance of N1s and CI 2p peaks located around 401.6 and 199.2 eV, respectively.

The high resolution C 1s XPS spectra for GO, graphene, and PDDA-graphene can be fitted with four different components of oxygen-containing functional groups; (a) non-oxygenated C at 284.6 eV, (b) carbon in C—O at 285.6 eV, (c) epoxy carbon at 286.7 eV, and (d) carbonyl carbon (C═O, 288.2 eV). Compared with GO, the graphene and PDDA-graphene samples showed a strong suppression for the oxygen-containing components of their C1s XPS spectra These results indicate efficient reduction of the oxygen-containing functional groups in GO by NaBH₄, particularly the epoxy. The N1s XPS spectra for pure PDDA shows a peak at around 402.0 eV that can be attributable to the charged nitrogen (N⁺). The negative shift to a lower binding energy (˜401.8 eV) in PDDA. Thus, PDDA appears to act as a p-type dopant to cause the partial electron-transfer from the electron-rich graphene substrate.

Characterization. Electrochemical measurements were performed using a computer-controlled potentiostat (CHI 760C, CH Instrument, USA) with a typical three-electrode cell. A platinum wire was used as the counter electrode and a saturated calomel electrode (SCE) was used as the reference electrode. All the experiments were conducted at room temperature (25±1° C.). For the electrode preparation, a non-functionalized graphene or PDDA-graphene suspension in ethanol (1 mg/ml) was prepared by introducing a predetermined amount of the corresponding graphene sample in ethanol under sonication. 10 μl of the graphene or PDDA-graphene suspension was then dropped onto the surface of a pre-polished glassy carbon electrode (GCE), followed by dropping 5 μL of a Nafion solution in isoproponal (0.5 wt %) as a binder.

For a comparison, a Pt/C electrode was also prepared as follows: Pt/C suspension was prepared by dispersing 10 mg Pt/C powder in 10 ml of ethanol in the presence of 50 μl of a 5% Nafion solution in isopropanol. The addition of a small amount of Nafion could effectively improve the dispersion of the Pt/C catalyst suspension.

X-ray photoelectron spectroscopic (XPS) measurements were performed on a VG Microtech ESCA 2000 using a monochromic Al X-ray source (97.9 W, 93.9 eV). Thermogravimetric analyses were carried out on a TA instrument with a heating rate of 10° C. under N₂. FTIR measurements were performed on a FTIR spectroscopy (PerkinElmer). Raman spectra were collected with a Renishaw inVita Raman spectrometer with an excitation wavelength of 514.5 nm. SEM images were recorded on a Hitachi S4800-F SEM.

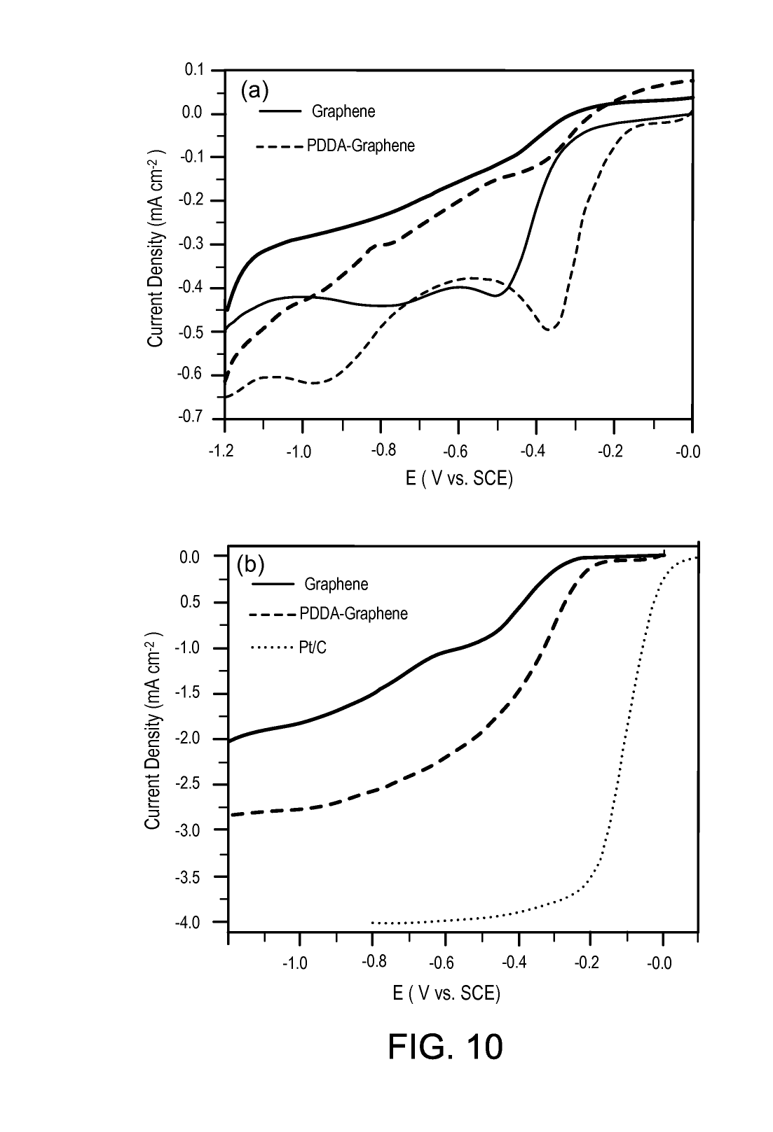

The use of PDDA-graphene as a metal-free catalyst was evaluated in the context of the electrochemical reduction of O₂. FIG. 10(a) shows the cyclic voltammograms (CVs) for oxygen reduction on the graphene and PDDA-graphene electrodes at a constant active mass loading (0.01 mg) in an aqueous O₂-saturated 0.1 M KOH solution. As can be seen, the onset potential of ORR for the pure graphene electrode is at −0.25 V (versus SCE) with the cathodic reduction peak around −0.47 V (versus SCE). With the PDDA-graphene, both the onset potential and the ORR reduction peak potential shifted positively to around −0.15 and −0.35 V, respectively, accompanied by a concomitant increase in the peak current density. These results demonstrate a significant enhancement in the ORR electrocatalytic activity for the PDDA-graphene in respect to the pure graphene electrode.

To further investigate the ORR performance, linear sweep voltammetric (LSV) measurements on a rotating disk electrode (RDE) were carried out with graphene and PDDA-graphene in an O₂-saturated 0.1 M KOH electrolyte solution. FIG. 10(b) compares, the ORR of the functionalized grapheme to a bare graphene electrode and a conventional Pt/C electrode. As shown in FIG. 4(b), the ORR of the bare graphene electrode commenced around −0.21 V (onset potential) whereas the ORR onset potential at the PDDA-graphene electrode significantly shifted positively to −0.12 V with the limiting diffusion current at −1.2V being about 1.4 times stronger than that of the graphene electrode. Although the ORR electrocatalytic activity of the as-prepared PDDA-graphene electrode is still lower than that of a commercial Pt/C electrode, the ease with which conventional nitrogen-free graphene materials can be converted into metal-free ORR electrocatalysts simply by the adsorption-induced of the electron-accepting material suggests considerable room for cost-effective preparation of various metal-free catalysts for ORR, and even new catalytic materials for applications beyond fuel cells (e.g., metal-air batteries).

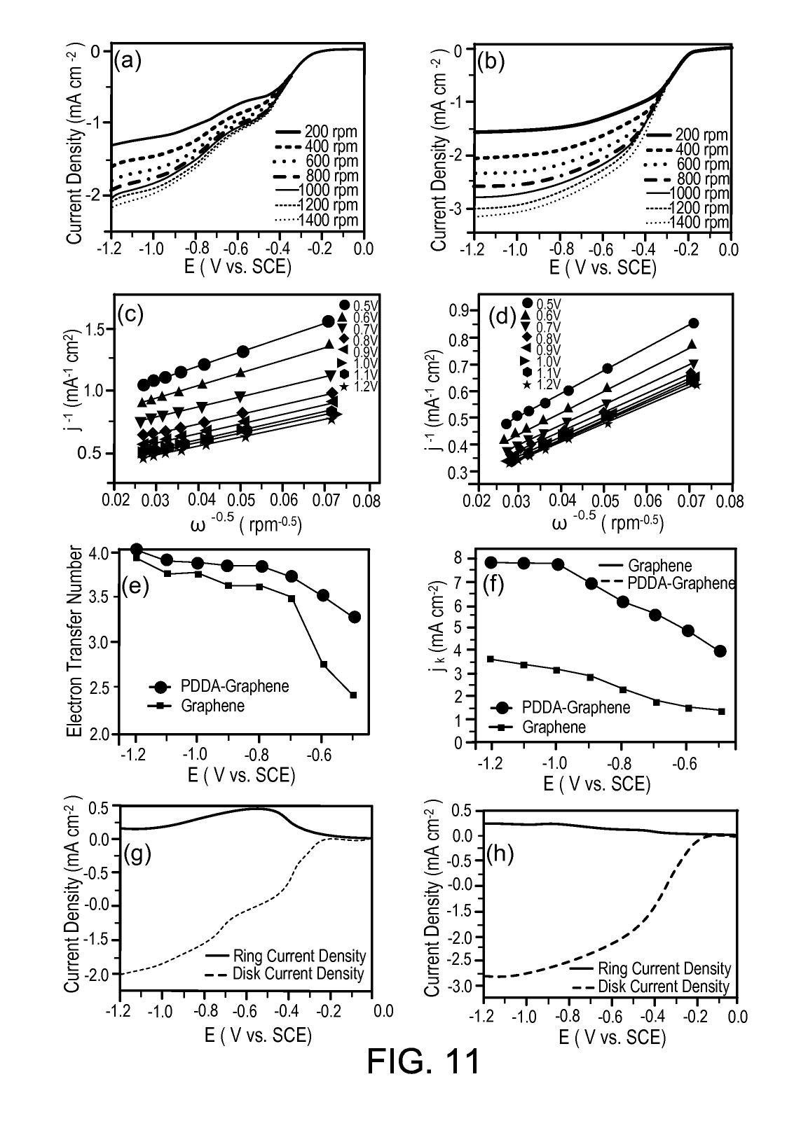

Rotating disk electrode (RDE) voltammetry measurements were also carried out to gain further insight on the ORR performance of the graphene electrode before and after functionalization/adsorption with PDDA. FIGS. 11(a)-(b) show the LSV curves at various different rotation rates for graphene (FIG. 11(a)) and PDDA-graphene FIG. 11(b) electrodes. As can be seen, adsorption of the hydrophilic PDDA chains, which facilitated interactions with the electrolyte, onto the graphene electrode (FIG. 11(a)) led to the much better diffusion controlled regions shown in FIG. 11(b). The limiting current density increases with increasing rotation rate. At any constant rotation rate, the limiting current density of ORR at the PDDA-graphene electrode is always higher than that at the pure graphene electrode.

The transferred electron numbers per O₂ involved in the oxygen reduction at both the graphene and PDDA-graphene electrodes were determined by Koutechy-Levich equation. As shown in FIGS. 11(c)-(d), linear relationships between i⁻¹ and ω^{-0.5} were observed for both the graphene and PDDA-graphene electrodes at various potentials. The number of electrons transferred per O₂ molecule (n) was calculated from the slope of the K-L plots, as shown in FIG. 11(e), in which the electron transfer number was found to be dependent on the potential for both the graphene and PDDA-graphene electrodes. In particular, the electron transfer number increased with a decrease in the negative potential. The electron transfer number for ORR at the PDDA-graphene electrode is always higher than that on the pure graphene electrode over the potential range covered in this study. Within the range of the electron transfer number from 2 to 4, the oxygen reduction reaction proceeds via a partial four-electron pathway. As seen in FIG. 11(e), the partial four-electron ORR reaction commenced at around −0.7 and −0.80 V on the PDDA-graphene and pure graphene electrode, respectively, indicating that PDDA-graphene is more efficient ORR electrocatalyst than graphene. This is consistent with the relatively high calculated kinetic current density, for ORR at the PDDA-graphene electrode with respect to the pure graphene electrode (FIG. 11(f)).

Rotation ring-disk electrode (RRDE) was also used to evaluate the ORR performance of the graphene and PDDA-graphene electrodes. FIGS. 11(g) and (h) show the disk and ring currents for the graphene and PDDA-graphene electrode, respectively. The ring currents were measured to estimate the amount of generated hydrogen peroxide ions. As can be seen, both of the electrodes started to generate the ring current at the onset potential for oxygen reduction. However, the amount of hydrogen peroxide ions generated on the PDDA-graphene electrode is significantly less than that on the pure graphene, indicating that PDDA-graphene is a more efficient ORR electrocatalyst. The electron transferred number (n) of ORR on graphene and PDDA-graphene estimated from the ring and disk currents. From the above equation the electron transfer number −0.5 V is estimated to be around 1.5 for graphene and 3.5 for PDDA-graphene, which is consistent with the K-L analyses.

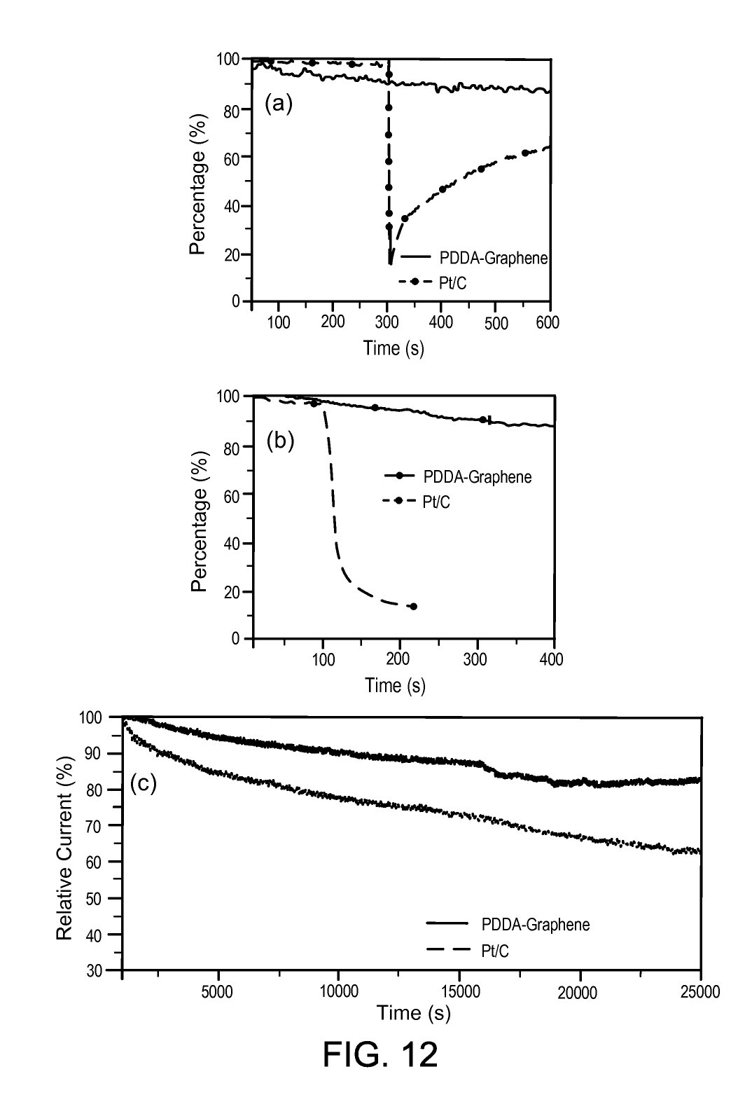

The PDDA-graphene electrode was further subjected to testing the possible crossover and the stability toward ORR. To examine the possible crossover effect in the presence of other fuel molecules (e.g., methanol) and the poisoning effect by carbon monoxide (CO), the current-time (i-t) chronoamperometric responses for ORR at the PDDA-graphene and Pt/C electrodes were obtained (FIGS. 12(a)-(c)) As shown in FIG. 12(a), a sharp decrease in current was observed for the Pt/C electrode upon addition of 3.0 M methanol. However, the corresponding amperometric response for the PDDA-graphene electrode remained almost unchanged even after the addition of methanol. This result unambiguously indicates that the PDDA-graphene electrocatalyst has higher fuel selectivity toward ORR than the commercial Pt/C electrocatalyst. To examine the effect of CO poisoning on the electrocatalytic activities of the PDDA-graphene and Pt/C electrodes, a CO gas was introduced into the electrolyte. As seen in FIG. 12(b), the PDDA-graphene electrode was insensitive to CO whereas the Pt/C electrode was rapidly poisoned under the same conditions.

Finally, the durability of the PDDA-graphene and commercial Pt/C electrodes for ORR was evaluated via a chronoamperometric method at 0.73 V in an O₂-saturated 0.1 M KOH at a rotation rate of 1000 rpm. As seen in FIG. 12(c), the current density from both the PDDA-graphene and Pt/C electrodes initially decreased with time. However, the PDDA-graphene electrode exhibited a much slower decrease than the Pt/C electrode and leveled off after continuous reaction for about 17000 seconds, indicating that the PDDA-graphene electrocatalyst is much more stable than the commercial Pt/C electrode.

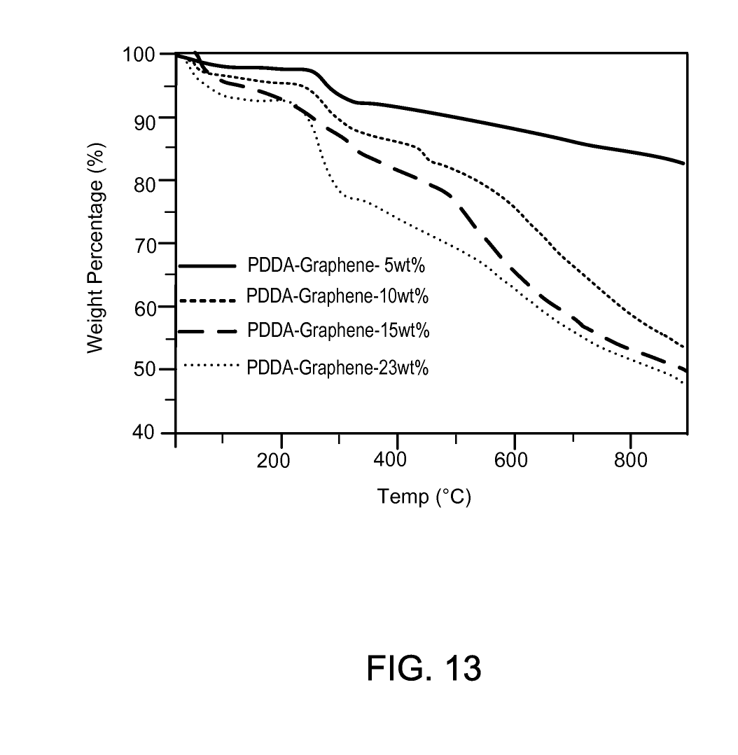

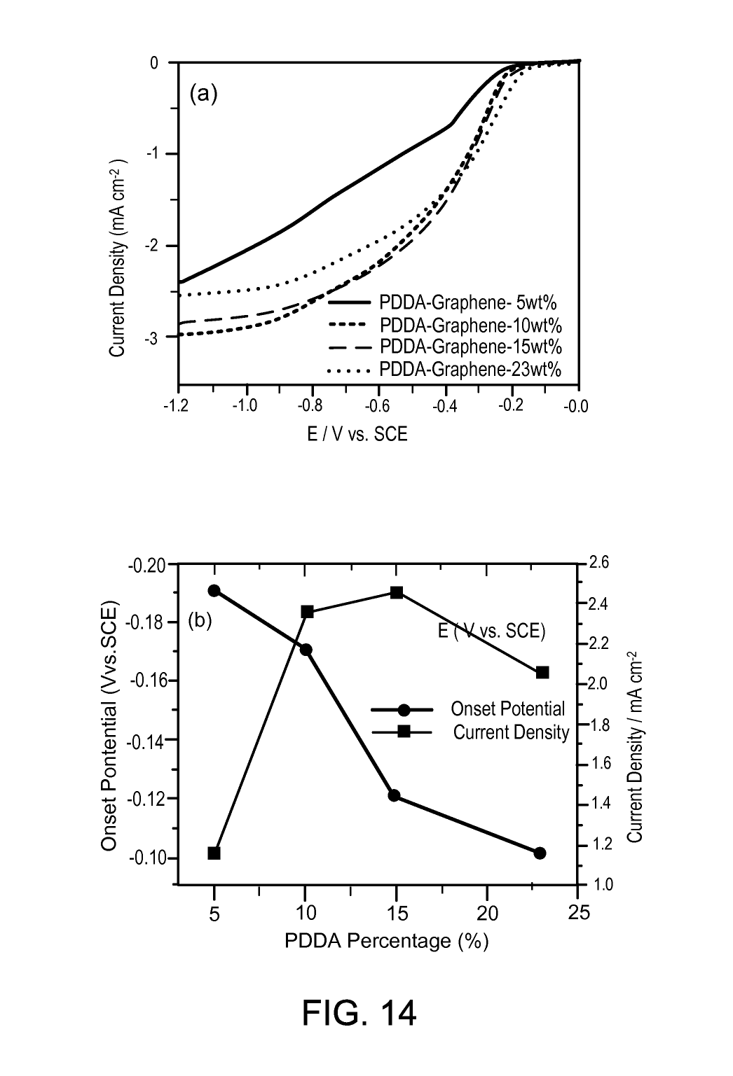

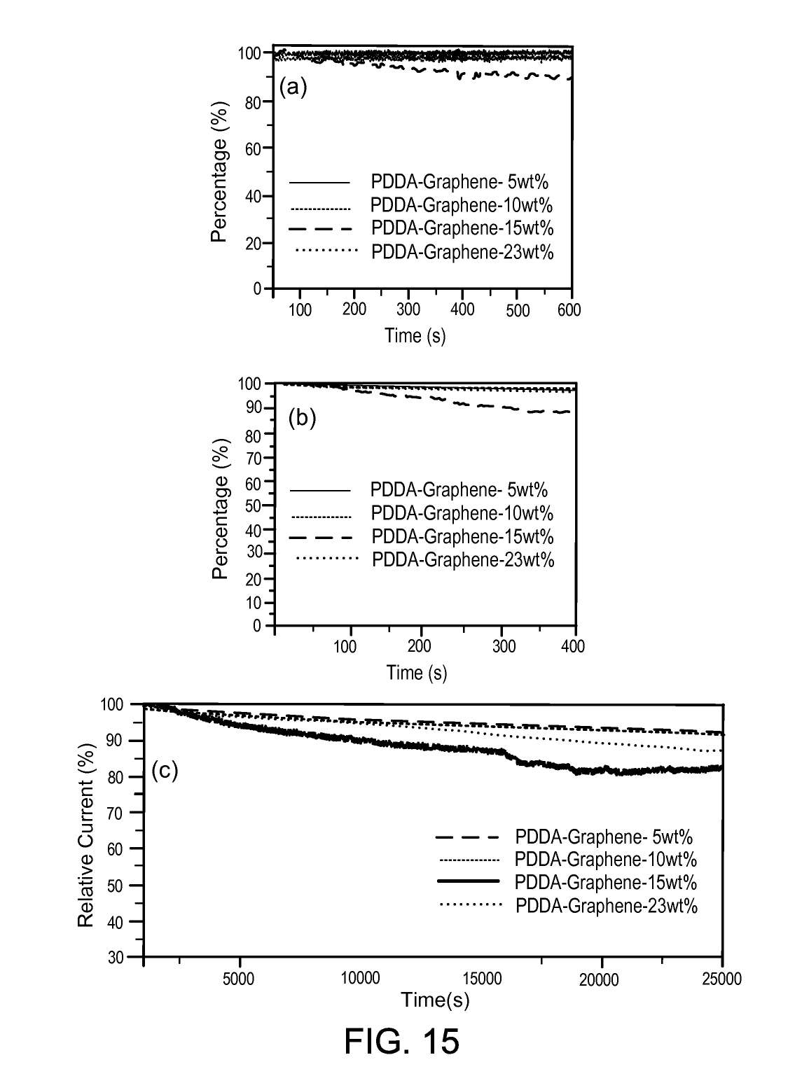

The effect of the concentration of adsorbed PDDA on the ORR activity, sensitivity, and stability was also analyzed. The PDDA amount was controlled by changing the feeding ratio of PDDA with graphene oxide during the reduction process. The amount of PDDA in the functionalized graphene was by TGA measurements to be 5 wt %, 10 wt %, 15 wt %, and 23 wt % (FIG. 13). TGA measurements were performed under nitrogen atmosphere with a heating rate of 10° C./min. The as-obtained samples were subjected to electrochemical testing for ORR with the LSV technique. As shown by the LSV data in FIG. 14(a)-(d), PDDA-graphene-with 15 wt % PDDA has a close activity to that of PDDA-graphene with 10 wt % of PDDA in terms of onset potential and current density, which had better activity for ORR than PDDA-graphene with 5 wt % of PDDA. While not being bound to any particular theory, this is understandable that more PDDA in the samples would contribute more significantly to the charge transfer process and thus more active activity. With the further increase of PDDA percentage to 23 wt %, the onset potential of ORR is significantly shifted to the positive direction; but the current density increased significantly (FIG. 14(b)). While not being bound to any particular theory, may result because when more PDDA chains adsorbed on the graphene surface the stronger intermolecular charge-transfer occurred, and hence the more positive-shift for the onset potential. On the other hand, the more PDDA chains adsorbed on graphene may block the more active for sites for ORR, leading to an initial increase, followed by a decrease, in the current density with increasing PDDA coverage (FIG. 14(b)). Furthermore, no obvious effect was found for the percentage of PDDA in the PDDA-graphene composites on the sensitivity toward methanol and CO and durability of the electrocatalysts, as shown in FIG. 15(a)-(c).

The above example shows that a graphene functionalized with an electron-accepting polyelectrolyte (e.g., PDDA) could act as an efficient metal-free electrocatalyst, while not being bound to any particular theory, the electrocatalytic activity may occur through intermolecular charge-transfer that creates a net positive charge on carbon atoms in the nitrogen-free graphene plane to facilitate the ORR catalytic activity. Notably, the PDDA-adsorbed graphene electrode shows remarkable ORR electrocatalytic activities with a better fuel selectivity, more tolerance to CO posing, and higher long-term stability than that of commercially available Pt/C electrode. Although the electrocatalytic activity of PDDA-graphene may be lower than that of nitrogen-doped carbon nanotubes and Pt/C, graphene materials can be produced by various low-cost large-scale methods, including the chemical vapor deposition, chemical reduction of graphite oxide, exfoliation of graphite, and the graphene can be readily functionalized, which provides for a cost-effective preparation of metal-free efficient graphene-based catalysts for oxygen reduction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A catalytic material comprising a carbon-based substrate, a non carbon-based substrate, or a combination of two or more thereof, the carbon-based substrate and/or non-carbon based substrate having an electron-accepting material adsorbed thereto.

2. The catalytic material of claim 1, wherein the electron-accepting material is chosen from a material comprising an amino group, a material comprising an ammonium group, a nitrogen-free electron accepting material, or a combination of two or more thereof.

3. The catalytic material of claim 1, wherein the electron-accepting material is chosen from polydiallyldimethyl ammonium chloride (PDDA), polyallylamine hydrochloride, methacryloxyethyltrimethyl ammonium chloride, acryloxyethyl dimethylbenzyl ammonium chloride, mefhacryloxyethyl dimethylbenzyl ammonium chloride, acryloxyethyltrimethyl ammonium chloride, or a combination of two or more thereof.

4. The catalytic material of any of claim 1, wherein the concentration of the electron-accepting material adsorbed to the substrate is about 50% or less by weight of the substrate.

5. The catalytic material of claim 1, wherein the concentration of electron-accepting material adsorbed onto the substrate is from about 5 to about 15% by weight of the substrate.

6. The catalytic material of claim 1, wherein the carbon-based material is chosen from carbon nanotubes, graphene, graphite, or a combination of two or more thereof.

7. The catalytic material of claim 1, wherein the carbon-based material comprises nonaligned carbon nanotubes, aligned carbon nanotubes, or a combination thereof.

8. The catalytic material of claim 1, wherein the substrate is substantially metal free.

9. An electrode comprising:
an electrode body; and
a catalytic layer disposed on a surface of the electrode body, that catalytic layer comprising a catalytic substrate comprising an array of carbon nanotubes, graphene, a graphite sheet, or a combination of two or more thereof, the carbon nanotubes graphene, and/or graphite sheet having an electron-accepting material adsorbed thereto.

10. The electrode of claim 9, wherein the electron-accepting material is a cationic polyelectrolyte.

11. The electrode of claim 10, wherein the cationic polyelectrolyte is chosen from a material comprising an amino group, a material comprising an ammonium group, or a combination of two or more thereof.

12. The electrode of claim 9, wherein the electron accepting material is chosen from a poly (diallylammonium chloride), poly(allylamine hydrochloride), methacryloxyethyltrimethyl ammonium chloride, acryloxyethyl dimethylbenzyl ammonium chloride, mefhacryloxyethyl dimethylbenzyl ammonium chloride, acryloxyethyltrimethyl ammonium chloride, or a combination of thereof

13. The electrode of claim 9, wherein the concentration of electron-accepting material adsorbed onto the catalytic substrate is, about 50% or less by weight of the catalytic substrate.

14. The electrode of claim 9, wherein the concentration of electron-accepting material is adsorbed onto the catalytic substrate is; from about 5% to about 15% by weight of the carbon nano-tube.

15. The electrode of claim 9, wherein the concentration of electron-accepting material is adsorbed onto the catalytic substrate is; from about 8% to about 12% by weight of the carbon nano-tube.

16. The electrode of claim 9, wherein the carbon nanotubes are nonaligned carbon nanotubes, aligned carbon nanotubes, or a combination thereof.

17. The electrode of claim 9, wherein the carbon nanotubes individually have a length of from about 5 μm to about 150 μm and/or individually have an outer diameter of from about 1 nm to about 80 nm.

18. The electrode of claim 9, wherein a portion of the surface of the electrode comprises glassy carbon, and the catalytic layer is disposed on the glassy carbon

19. The electrode of claim 9, wherein the electrode is a cathrode.

20. An electrochemical device comprising the electrode of claim 9.

21. The electrochemical device of claim 20, where the device is chosen from a fuel cell, a battery, and a biosensor.

22. A method of forming an electrode material comprising an array of carbon nanotubes having an electron-accepting material adsorbed thereto, the method comprising:
(a) providing a carbon nanotube array disposed on a substrate;
(b) coating the carbon nanotube array with the electron-accepting material;
(c) drying the nanotube array from (b);
(d) removing the substrate to provide a free-standing functionalized nanotube array; and
(e) attaching the free standing functionalized nanotube array to an electrode body.

23. The method of claim 22, wherein (a) comprises spin coating the electron-accepting material into the nanotube array.

24. The method of claim 23, comprising repeating steps (b) and (c) one or more times.

25. The method of claim 24, wherein drying the nanotube array comprises drying in air at a temperature of from about 4° C. to about 100° C.

26. A fuel cell comprising:
a fuel cell body;
an oxidant inlet configured to fluidly couple the fuel cell body to an oxidant source;
a fuel inlet configured to fluidly couple the fuel cell body to a fuel source;
an exhaust outlet;
a fuel cell cathode fluidly coupled to the oxidant inlet; a fuel cell anode fluidly coupled to the fuel inlet and the exhaust outlet;
at least one electrolyte configured to enable flow of ions between the fuel cell cathode and the fuel cell anode;
an electrically insulating ion-permeable membrane disposed within the fuel cell body between the fuel cell cathode and the fuel cell anode, the electrically insulating membrane configured to prevent flow of electrons between the fuel cell anode and the fuel cell cathode through the electrolyte;
and an external circuit isolated from the electrolyte and electrically coupling the fuel cell anode and the fuel cell cathode;
wherein the fuel cell cathode comprises (a) a cathode body electrically coupled to the external circuit; and (b) a catalytic layer electrically coupled to the electrolyte and the cathode body, the catalytic layer comprising a plurality of functionalized carbon nanotubes, a functionalized graphene, a functionalized graphite, or a combination of two or more thereof, the functionalized carbon nanotubes, graphene and/or graphite comprising an electron-accepting material adsorbed to the carbon nanotubes, graphene, or graphite.

27. The fuel cell of claim 26, wherein the electron-accepting material is chosen from polydiallyldimethyl ammonium chloride (PDDA), polyallylamine hydrochloride, methacryloxyethyltrimethyl ammonium chloride, acryloxyethyl dimethylbenzyl ammonium chloride, mefhacryloxyethyl dimethylbenzyl ammonium chloride, acryloxyethyltrimethyl ammonium chloride, or a combination of two or more thereof.

28. The electrode of claim 26, wherein the concentration of electron-accepting material adsorbed onto the carbon nanotubes, graphene, or graphite is from about 5 to about 15% by weight of the carbon nano-tube, graphene, or graphite.

29. The electrode of claim 26, wherein the concentration of electron-accepting material adsorbed onto the carbon nanotubes, graphene, or graphite is from about 8 to about 12% by weight of the carbon nanotube, graphene, or graphite.

30. The electrode of claim 26, wherein the carbon nanotubes are nonaligned carbon nanotubes, aligned carbon nanotubes, or a combination thereof.

31. The electrode of claim 26, wherein the carbon nanotubes individually have a length of from about 5 μm to about 150 μm and/or individually have an outer diameter of from about 1 nm to about 80 nm.

32. The electrode of claim 26, wherein a portion of the surface comprises glassy carbon, and the catalytic layer is disposed on the glassy carbon.
